(19) United States
(12) Patent Application Publication
(10) Pub. No.: US 2008/0313175 A1
(43) Pub. Date: Dec. 18, 2008

(54) METHOD AND SYSTEM FOR INTERACTION-BASED EXPERTISE REPORTING

(75) Inventors: Mik Kersten, Vancouver (CA); Gail C. Murphy, Vancouver (CA); Nathan Hapke, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: THE UNIVERSITY OF BRITISH COLUMBIA, Vancouver (CA)

(21) Appl. No.: 12/135,902

(22) Filed: Jun. 9, 2008

Related U.S. Application Data
(60) Provisional application No. 60/943,922, filed on Jun. 14, 2007.

(51) Int. Cl. G06F 7/06; G06F 17/30

(52) U.S. Cl. 707/5; 707/E17.014

(57) ABSTRACT

A task-based method and system for expertise reporting provides a display of a knowledge worker's expertise in structured documents based on their access and use of those documents.

### REFERENCE TO RELATED APPLICATION

This application claims the benefit of U.S. provisional application No. 60/943,922 filed Jun. 14, 2007 entitled “Method and System for Interaction-based Expertise Reporting”, which is incorporated herein by reference.

### TECHNICAL FIELD

The invention relates to the field of systems for managing and sharing-expertise, particularly collaboration on electronic works such as collaboration among computer programmers.

### BACKGROUND

In the current knowledge-based economy, something approaching one out of every four employees is a knowledge-based worker. Most of these employees are working with structured documents such as electronic files, web pages and the like. Improving the management of such workers for improved productivity is an important goal. It may be important for managers to be able to determine which worker has expertise in a particular area. For example, in the writing of software code or other electronic projects, often a number of individuals work in collaboration. In such situations it may be helpful for a manager to be able to determine which of the programmers is an expert on a particular section of the code. It may also be important for improving productivity to have the employees spend less time searching for the artifacts of interest to a particular project, so it may be helpful to know which workers have accessed particular documents when working on the project.

A number of approaches to expertise reporting are presently used. The problem with existing methods is they do not include who considered what information categorized by task and weighting expertise by frequency and recency of interaction with the information. U.S. Pat. No. 6,377,983 discloses a method and system for converting expertise based on document usage. A user can access a browse path of another user, such as an expert, in a particular content area. U.S. Pat. No. 6,928,425 discloses a system for propagating enrichment between documents. It uses interaction history for document enrichment rather than expertise. United States Published Patent Application Publication no. 2006/0200794 discloses a system and method for managing user interaction data in a networked environment which involves gathering and displaying user interaction data. None of these provide a task-based analysis.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The invention provides a method and system for reporting expertise. Each task which is worked on by a user is given a name. Each time a user works on files on the system, or interacts on networked resources such as web pages, the system records the task context, consisting of the interaction stream or history which is generated as the user works on the selected task. Tasks and their associated contexts are recorded and saved in the system database. A Reporting User requests an expertise report by entering a query to specify a subset of tasks which is to be covered by the report. The query is executed, and the requested subset of tasks and associated task contexts are extracted from the task repository. The document structure for each element found in the context is extracted from the task contexts. The individual users/people who worked on the task contexts are also extracted. The system then formats a display of documents and people to calculate and display the Degree of Interest. For a given person, the system finds the contexts on which the person worked. For each context, the system processes the context through Degree of Interest (DOI) modeling, producing the DOI of a person in each element (document) mentioned in the contexts. The system stores the aggregate DOI of a person in documents mentioned in the contexts in a selected display format, such as a grid. Once the display format has been completed for all persons it is displayed to the Reporting User.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic diagram illustrating the invention.

FIG. 2 is a flowchart illustrating the invention.

FIG. 3 is a schematic diagram illustrating the invention.

FIG. 4 is a screen shot from the invention.

FIG. 5 is a screen shot from the invention.

FIG. 6 is a screen shot from the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

For purposes of this application, a “piece of structured information” is a piece of information which has a specified location. Examples are web pages, and files which are identified by location. An “element” is a piece of structured information or a parent of a piece of structured information in the hierarchy of structured information. An element is also referred to as an “artifact”. A “task” is any unit of work as defined by the user. A task can be defined by the user or taken from a task repository, such as bug/ticket/issue trackers like Bugzilla, Trac or JIRA. In the following description and claims, the term “document” includes pieces of structured information, which includes files as well as networked resources such as web pages.

Various software applications exist for tracking and monitoring. One such software application which is particularly useful for the present invention is Eclipse Mylyn (“Mylyn”). Other monitoring software can be used in the present invention provided it establishes tasks that are worked on and lists which structured information was accessed as part of the task. Mylyn is an open-source task-focused user interface on the Eclipse platform that reduces information overload and makes multi-tasking easier. It does this by making tasks a part of Eclipse, and integrating offline editing for repositories such as Bugzilla, Trac and JIRA. Once the tasks are integrated, Mylyn monitors the user's work activity to identify information relevant to the task-at-hand, and uses this task context to focus the Eclipse user interface on the interesting information, hide the uninteresting, and automatically find what is related. This improves productivity by reducing searching, scrolling, and navigation. By making task context explicit, Mylyn also facilitates multitasking, planning, reusing past efforts, and sharing expertise.

Mylyn monitors a programmer's activities and captures the relevance of code elements to their tasks in a degree-of-interest model (DOI). For example, when a programmer selects or edits a program element, Mylyn increases the interest level of that element. Mylyn uses the DOI model to populate views within the Eclipse IDE. Mylyn is described in the paper “Mylyn: a degree-of-interest model for IDEs” by Mik Kersten and Gail C. Murphy published at the March 2005 AOSD conference, and the paper “Using task context to improve programmer productivity” by Mik Kersten and Gail C. Murphy published at the 2006 Foundations of Software Engineering Symposium, which are incorporated herein by reference.

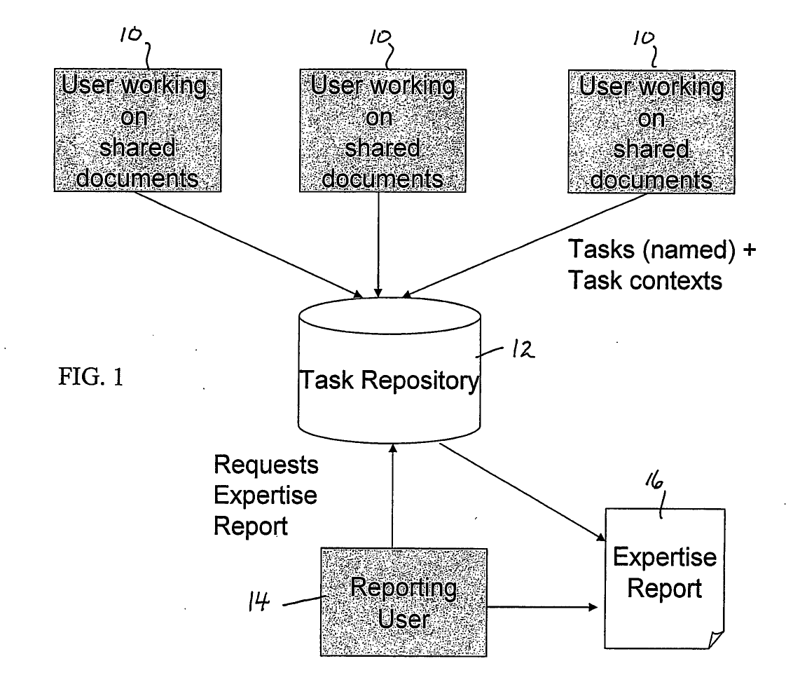

With reference to FIG. 1, a number of users 10, for example knowledge workers working with structured documents, such as software programmers, are working on shared documents, using computers operating the Eclipse Mylyn interface and communicating over a local or wide area network. As provided in the Mylyn user interface, each task which is worked on by user 10 is given a name. It may be a shared task or a local task. It may be named by the user who created the task or drawn from a Task Repository 12 which is a database storing the task names and associated contexts, as described below. Task Repository 12 may be maintained by issue tracker software such as Bugzilla, Trac or JIRA. Each time a user 10 works on files on the system, including shared network resources such as web pages, he/she activates the task in Mylyn on which the user is working, and Mylyn records the task context. The task context consists of the interaction stream or history which is generated as the user works on the selected task. Each task context is associated with a particular user's interaction stream, so that a task may have multiple task contexts associated with different individual users and/or multiple task contexts for a given user. The interaction stream comprises a time line of the elements or artifacts accessed, an identification of the element, the duration of the access and the activity performed, such as selection (mouse click), edit commands, manipulation (choosing certain menu items), user attention changes and the like. Mylyn calculates a Degree of Interest for a given element based on the interaction stream and other factors, such as propagation and prediction.

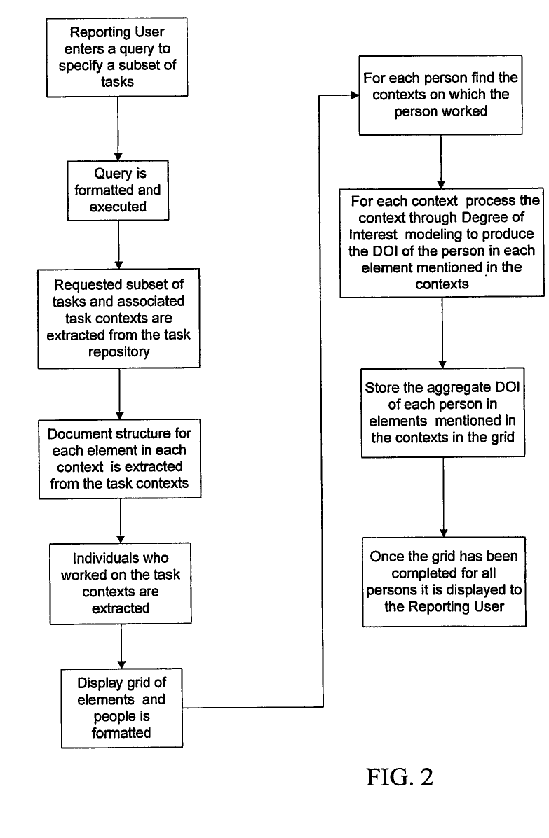

All tasks and their associated contexts are recorded and saved in the system Task Repository database 12. A Reporting User 14 (for example, a manager) can request an expertise report from the Task Repository 12. The system generates the expertise report 16 following the steps shown in FIG. 2. First the Reporting User 14 enters a query to specify a subset of tasks which is to be covered by the report. For example, the query may be to include all tasks by particular individuals, or all tasks performed over a certain time period, or all tasks which contain a keyword in the title, or all tasks stored in the repository. The query is formatted and executed, and the requested subset of tasks and associated task contexts are extracted from the task repository. The document structure for each element found in the context, which is stored as a string, is extracted from the task contexts. The individual users/people who worked on the task contexts are also extracted. The system then formats a grid of documents and people to calculate and display the Degree of Interest.

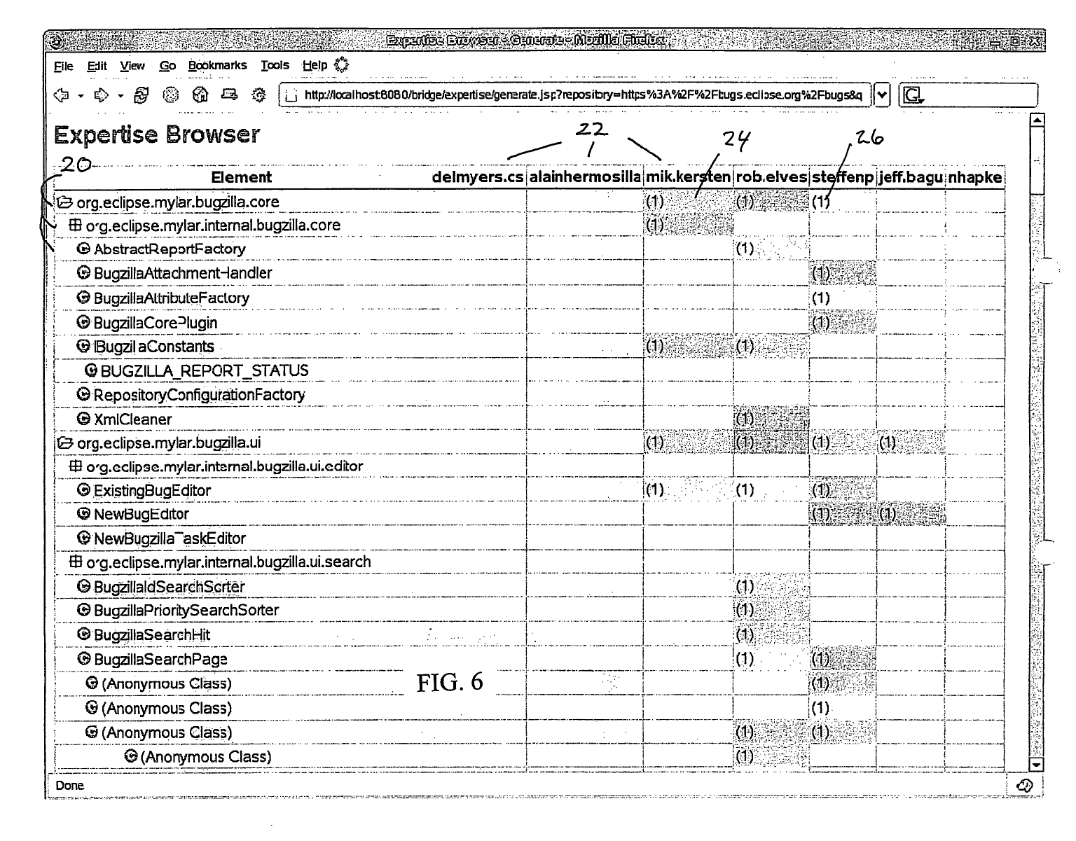

For a given person A, the system finds the contexts on which the person worked. For each context B, the system processes the context through Degree of Interest (DOI) modeling, using Mylyn's algorithm for calculating the DOI, producing the DOI of person A in each element (document) mentioned in the contexts. The system stores the aggregate DOI of person A in documents mentioned in the contexts in a grid. Once the grid has been completed for all persons it is displayed to the Reporting User 14 as shown in FIG. 6.

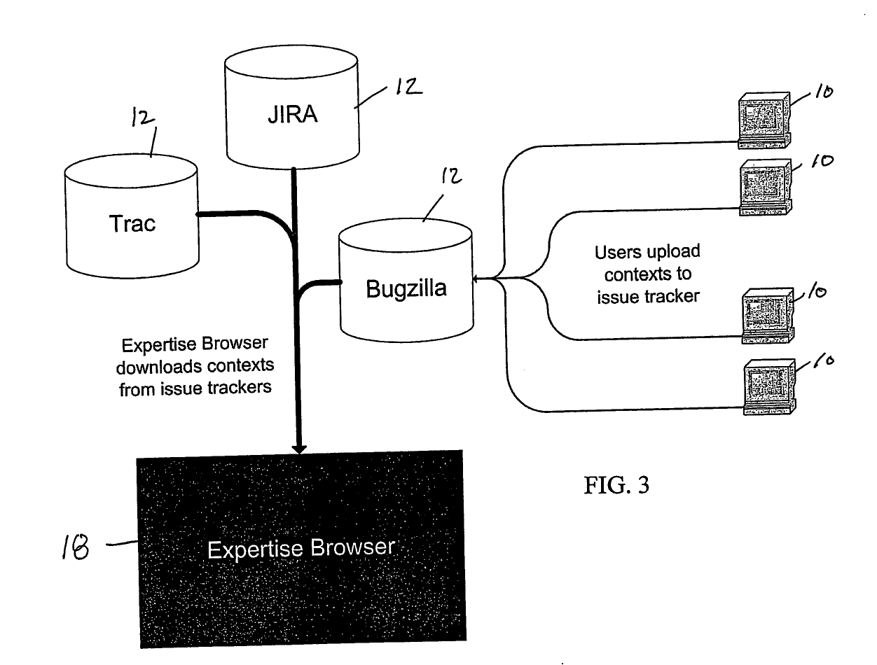

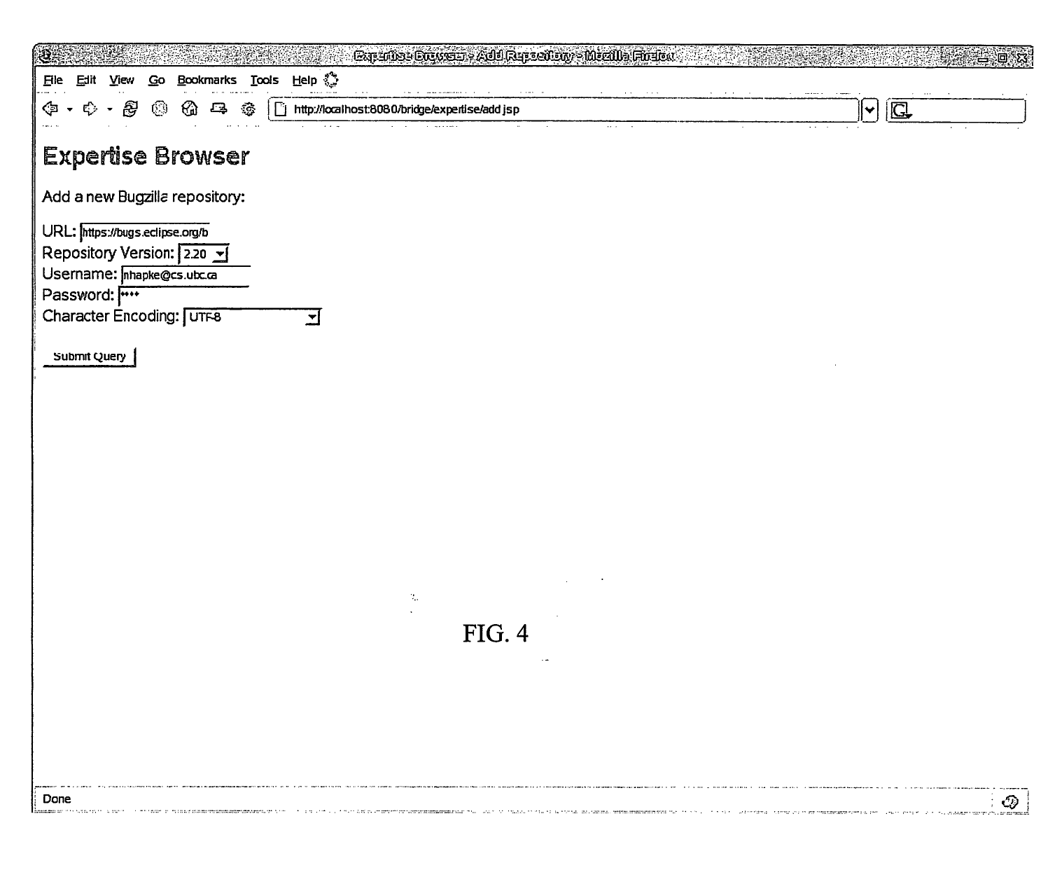

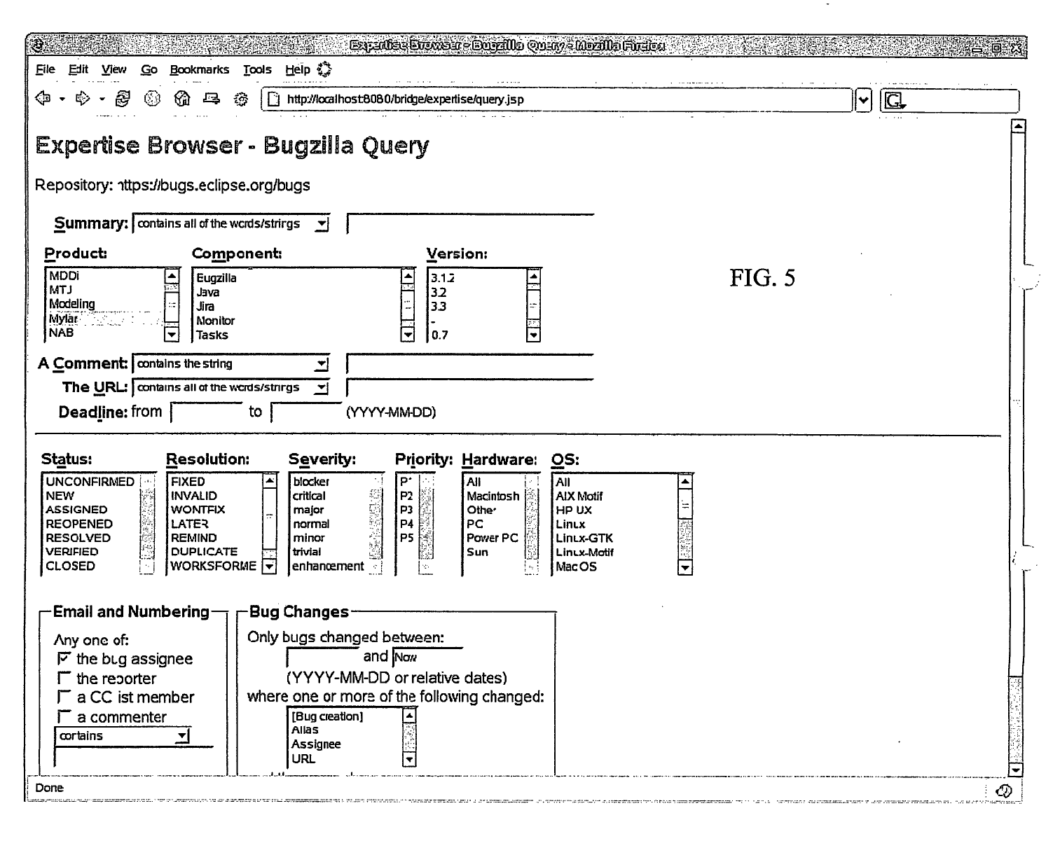

FIG. 3 further illustrates the Expertise Reporting system. Users 10 upload contexts to the task repository databases 12. The task repositories 12 may be maintained by issue tracking software as Trac, JIRA or Bugzilla or other software for which a connector is available that supports attaching contexts to the bugs (issues). The Expertise Browser 18 downloads the contexts from the issue tracker to calculate the DOI and prepare the expertise report 16. A repository over which expertise can be queried can be added. FIG. 4 is a screen shot of the Expertise Browser's page displayed to the Reporting User showing the page for adding a task repository from issue tracking software. FIG. 5 is a screen shot of a page from the system for formulating the query, in this case to query a task repository from issue tracking software.

FIG. 6 is a screen shot of the Expertise Report displayed as a grid. The column entitled “Element” lists the elements which were extracted from the task contexts by the query, in hierarchical order, each element forming a horizontal row 20. The persons who worked on the tasks located by the query are listed horizontally across the top of the grid, forming columns 22. The DOI of a person for a particular element is indicated by the darkness or color of the shading in the column 20 corresponding to that person and the row 20 corresponding to the element. For example the DOI of mik.kersten in org.eclipse.Mylyn.bugzilla.core is shown by the shading of box 24. Numerals at 26 show the number of contexts which contributed to the DOI calculation. By double-clicking on one of the boxes 24 the Reporting User is displayed the tasks that were worked on by the person in that column with the element in that row.

The invention permits the tracking of interactions in parts of a document. The interactions can then be aggregated to an entire document. Thus the system can track sub-structures and aggregate to the complete structure. For example, section accesses can be tracked within a Microsoft Word document and the expertise displayed at the section level or the entire document level or both.

The benefit of the invention is that the Reporting User can immediately visually analyze who the experts are in a particular area and which documents they are accessing. It will be apparent to those skilled in the art that other displays will also be useful, such as a bar graph or purely textual display. Also while the display shows persons and documents (elements) it could also display tasks instead of persons in the grid. The system can be used for expertise reporting for any knowledge workers working on structured documents. While Mylyn is the preferred application to generate the DOI, any tracking or monitoring software which tracks tasks, lists the structured information accessed as part of the task, and generates a value for the interaction with the structured information can be used.

While a number of exemplary aspects and embodiments have been discussed above, those of skill in the art will recognize certain modifications, permutations, additions and sub-combinations thereof. It is therefore intended that the invention be interpreted to include all such modifications, permutations, additions and sub-combinations as are within its true scope.

What is claimed is:

1. In a computer system wherein a plurality of users carry out tasks on documents via a computer network, a task-based method for reporting expertise of one or more of said users to one or more reporting users of the computer system, the computer system comprising data storage means, the method comprising:
i) assigning a name to each task which is worked on by a user;
ii) recording a task context each time one of said users works on a document or part of a document on the system, wherein the task context comprises the interaction history which is generated as a user works on a task;
iii) storing said tasks and their associated task contexts;
iv) requesting an expertise report by a reporting user entering a query to specify the tasks to be covered by the report;
v) extracting the specified tasks and associated task contexts from storage;
vi) calculating a degree of interest for each user in documents mentioned in the associated task contexts by, for each user, finding the associated task contexts on which the user worked and for each associated task context, producing the degree of interest of the user in each document mentioned in the associated task contexts;
vii) displaying the expertise report to the reporting user by displaying the degrees of interest of all said mentioned users in each document or part of a document mentioned in the associated task contexts.

2. The method as recited in claim 1 wherein said users work on parts of a document and said expertise report displays the degrees of interest in said parts of a document.

3. The method as recited in claim 1 wherein said users work on parts of a document and said expertise report aggregates the degrees of interest in said parts of a document and displays the degrees of interest in the entirety of said document.

4. The method as recited in claim 1 wherein the expertise report is displayed in a selected display format.

5. The method as recited in claim 4 wherein the expertise report is displayed in a grid.

6. The method as recited in claim 4 wherein the expertise report is displayed in a bar graph.

7. The method as recited in claim 4 wherein the expertise report is displayed in a text display.

8. The method as recited in claim 5 wherein the documents or parts of documents mentioned in the associated task contexts form the columns or rows of said grid.

9. The method as recited in claim 8 wherein user identifications form the columns or rows of said grid.

10. The method as recited in claim 8 wherein the specified tasks form the columns or rows of said grid.

11. The method as recited in claim 9 wherein the degree of interest of a user in a document or part of a document is indicated visually.

12. The method as recited in claim 9 wherein the degree of interest of a user in a document or part of a document is indicated by the color or darkness of shading of the area of intersection of the column and row for the said user and document.

13. The method as recited in claim 10 wherein the degree of interest of a user in a document or part of a document is indicated visually.

14. The method as recited in claim 10 wherein the degree of interest of a user in a document or part of a document is indicated by the color or darkness of shading of the area of intersection of the column and row for the said user and document.

15. A computer readable medium storing one or more software programs which, when executed, cause a computer in a computer system wherein a plurality of users carry out tasks on documents via a computer network, to perform a task-based method for reporting expertise of one or more of said users to one or more reporting users of the computer system, the computer system comprising data storage means, the method comprising:
i) assigning a name to each task which is worked on by a user;
ii) recording a task context each time one of said users works on a document or part of a document on the system, wherein the task context comprises the interaction history which is generated as a user works on a task;
iii) storing said tasks and their associated task contexts;
iv) requesting an expertise report by a reporting user entering a query to specify the tasks to be covered by the report;
v) extracting the specified tasks and associated task contexts from storage;
vi) calculating a degree of interest for each user in documents mentioned in the associated task contexts by, for each user, finding the associated task contexts on which the user worked and for each associated task context, producing the degree of interest of the user in each document mentioned in the associated task contexts;
vii) displaying the expertise report to the reporting user by displaying the degrees of interest of all said mentioned users in each document or part of a document mentioned in the associated task contexts.

16. The computer readable medium as recited in claim 15 wherein said users work on parts of a document and said expertise report displays the degrees of interest in said parts of a document.

17. The computer readable medium as recited in claim 15 wherein said users work on parts of a document and said expertise report aggregates the degrees of interest in said parts of a document and displays the degrees of interest in the entirety of said document.

18. The computer readable medium as recited in claim 15 wherein the expertise report is displayed in a selected display format.

19. The computer readable medium as recited in claim 18 wherein the expertise report is displayed in a grid.

20. The computer readable medium as recited in claim 18 wherein the expertise report is displayed in a bar graph.

21. The computer readable medium as recited in claim 18 wherein the expertise report is displayed in a text display.

22. The computer readable medium as recited in claim 19 wherein the documents or parts of a document mentioned in the specified task contexts form the columns or rows of said grid.

23. The computer readable medium as recited in claim 22 wherein the users form the columns or rows of said grid.

24. The computer readable medium as recited in claim 22 wherein the specified tasks form the columns or rows of said grid.

25. The computer readable medium as recited in claim 23 wherein the degree of interest of a user in a document or part of a document is indicated visually.

26. The computer readable medium as recited in claim 23 wherein the degree of interest of a user in a document or part of a document is indicated by the color or darkness of shading of the area of intersection of the column and row for the said user and document.

27. The computer readable medium as recited in claim 24 wherein the degree of interest of a user in a document or part of a document is indicated visually.

28. The computer readable medium as recited in claim 24 wherein the degree of interest of a user in a document or part of a document is indicated by the color or darkness of shading of the area of intersection of the column and row for the said user and document.
